(19) United States
(12) Patent Application Publication
(10) Pub. No.: US 2014/0244454 A1
(43) Pub. Date: Aug. 28, 2014

(54) SYSTEM AND METHODS FOR INCREASING BUSINESS VISIBILITY AND ACCOUNTABILITY USING LINKED NOTIFICATIONS AND ACCOUNTABILITY AUDITORS

(71) Applicants: Andrew GRIMES, Mesa, AZ (US); Jason NESBIT, Gilbert, AZ (US)

(72) Inventors: Andrew GRIMES, Mesa, AZ (US); Jason NESBIT, Gilbert, AZ (US)

(21) Appl. No.: 14/194,170

(22) Filed: Feb. 28, 2014

Related U.S. Application Data
(60) Provisional application No. 61/770,430, filed on Feb. 28, 2013.

(51) Int. Cl. G06Q 40/00

(52) U.S. Cl. CPC G06Q 40/12
USPC 705/30

(57) ABSTRACT

A method including the steps of: identifying, using one or more processors, business data associated with problems within a business environment; generating, using one or more processors, one or more notifications related to the identified business data; sending, using one or more processors, the one or more notifications to a computer system associated with a user; monitoring, using one or more processors, the user's interaction with the business data; and reporting, using one or more processors, the monitored interaction with the business data.

### RELATED APPLICATION

This application claims priority to U.S. Provisional Patent Application Ser. No. 61/770,430, the contents of which are incorporated herein by reference in their entirety.

### FIELD

The present disclosure relates to systems and methods for increasing business visibility and accountability using linked notifications and accountability auditors.

### SUMMARY OF THE INVENTION

A method according to an exemplary embodiment of the present invention comprises the steps of: identifying, using one or more processors, business data associated with problems within a business environment; generating, using one or more processors, one or more notifications related to the identified business data; sending, using one or more processors, the one or more notifications to a computer system associated with a user; monitoring, using one or more processors, the user's interaction with the business data; and reporting, using one or more processors, the monitored interaction with the business data.

In at least one embodiment, the step of identifying comprises exception processing.

In at least one embodiment, the step of sending comprises sending the one or more notifications in a format selected from a group consisting of: e-mail, SMS, MMS, mobile message, and callback number.

In at least one embodiment, the step of monitoring comprises logging the user's interaction with the business data.

### BRIEF DESCRIPTION OF THE DRAWINGS

The features and advantages of the present disclosure will be more fully understood with reference to the following, detailed description when taken in conjunction with the accompanying figures, wherein:

FIG. 1 is a block diagram of certain components of the systems and methods for increasing business visibility and accountability using linked notifications and accountability auditors, in accordance with exemplary embodiments of the present disclosure; and

FIG. 2 is a flow chart illustrating an exemplary use of the systems and methods for increasing business visibility and accountability using linked notifications and accountability auditors, in accordance with exemplary embodiments of the present disclosure.

### DETAILED DESCRIPTION

The disclosure generally relates to systems and methods that can be used in industry (e.g., retail industry) to increase business visibility into operational improvements by, for example, using proactive notifications communicated to users for targeted improvement areas with process auditing. The notifications communicated to users can be actively linked back into the actual system data that can be generated from a point of sale device and/or stored in a data warehouse. Further, the systems and methods can include accountability auditing that can confirm whether changes are, for example, being actively implemented in response to notifications communicated to users.

In exemplary embodiments, the system and methods can be used with businesses vertical of a retailer and can use point of sale data to provide specifics on, for example, job function to increase business visibility into operational improvements. Further, in exemplary embodiments, this data can be used in conjunction with algorithms of retail consultants and/or mathematical statistics to increase business visibility into operational improvements by, for example, ranking and exposing the largest opportunities. Further still, in exemplary embodiments, the system and methods can take these opportunities and measure the effectiveness of, for example, front line workers, in the field, taking action and wrapping accountability in to various areas and/or levels of the organization for improvement implementation.

In exemplary embodiments, the system and methods can notify users and can also allow users to actively link back to the actual data within the system that supports the problem being described in the notification. This can be done using the retailer's Point of Sale (POS) data that can be accumulated during normal business operations and/or coupling that data with workflow process analysis to discover problems within the business environment.

In exemplary embodiments, notifications can include links back to the actual system data. By way of example, users receiving a notification can, with a link, be sent to a web page where they can see the data that created the notification issue. Further, in exemplary embodiments, the user can view and look at data that lead the system and methods to generate and/or deliver the notification.

In exemplary embodiments, activity on notifications can be monitored and/or can be used to report user activity level with respect to the notifications. Further, in exemplary embodiments, notifications that fail to be addressed by the user in a timely matter can be automatically escalated to the user's supervisor. This can be used to enforce accountability for follow through on notifications.

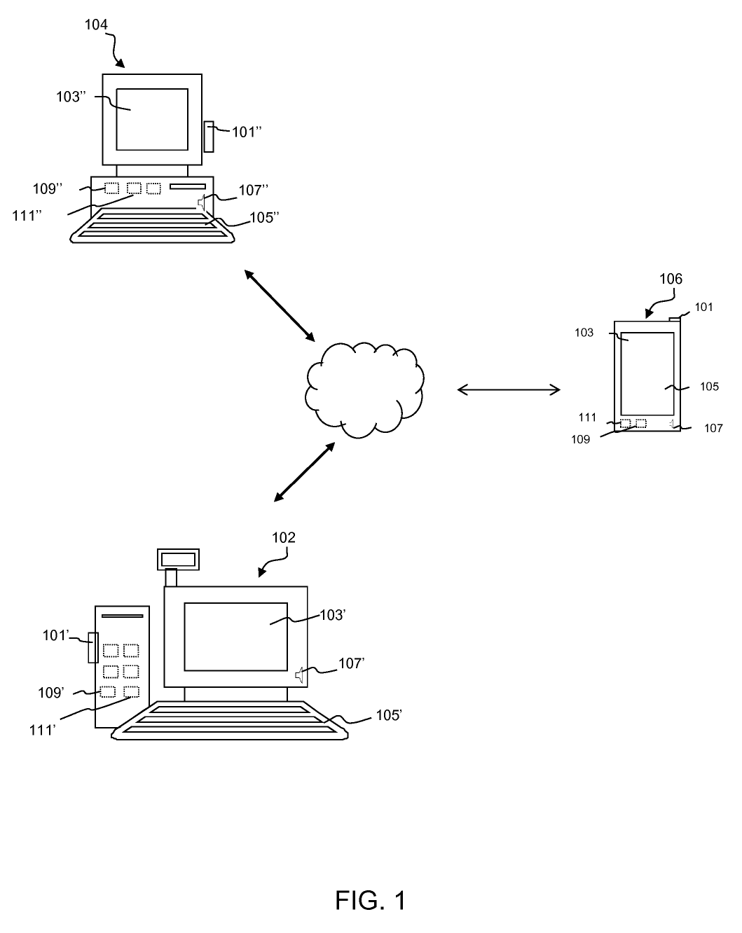

Referring to FIG. 1, in exemplary embodiments, the system and methods can be implemented, accessed, and/or be affiliated with any of a point of sale device 102, a data warehouse and analyzer 104, and/or a user device 106. Further, to implement, access, and/or be affiliated with each other, any of point of sale device 102, data warehouse and analyzer 104, and/or user device 106 can communicate with each other and/or can be further combined and/or separated. For ease, point of sale device 102, data warehouse and analyzer 104, and/or user device 106 are, at times, shown separately. This is merely for ease and is in no way meant to be a limitation. Further, any element of point of sale device 102, data warehouse and analyzer 104, and/or user device 106 can reside on and/or be affiliated with each other.

As shown, point of sale device 102, data warehouse and analyzer 104, and/or user device 106 can include, but is not limited to, at least one communication portal 101, 101′, 101″; at least one graphical user interface 103, 103′, 103″; at least one user input 105, 105′, 105″; at least one speaker 107, 107′, 107″; at least one processor readable memory 109, 109′, 109″; at least one processor 111, 111′, 111″; and any other reasonable components for use in communicating information (e.g., data), storing information, and processing any form of information.

In some instances, graphical user interface 103, 103′, 103″ and user input 105, 105′, 105″ can be substantially the same. For example, graphical user interface 103, 103′, 103″ and user input 105, 105′, 105″ can be combined as a touch distribution system. The touch distribution system can be a display that can detect the presence and location of a touch within the distribution system area.

By way of example, point of sale device 102, data warehouse and analyzer 104, and/or user device 106 can be, for example, a mobile phone, smartphone, computer, server, and tablet, to name a few.

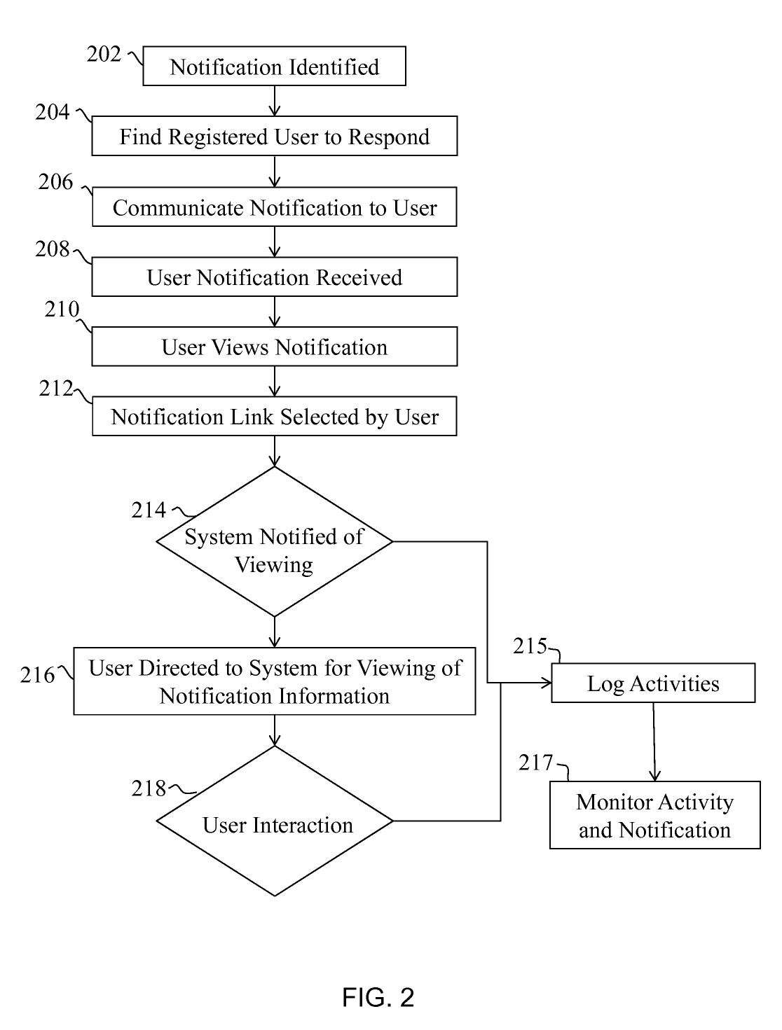

Referring to FIG. 2, in exemplary embodiments, the system and methods, utilizing point of sale device 102, data warehouse and analyzer 104, and/or user device 106, can implement the steps shown to increase business visibility and/or accountability using linked notifications and/or accountability auditors. For example, the system and methods can identify a notification, at step 202.

In exemplary embodiments, a notification can be identified and/or defined using a targeting system. In exemplary embodiments, the targeting system can be a program and/or computer implemented process stored in processor readable memory accessible by a processor affiliated with point of sale device 102, data warehouse and analyzer 104, and/or user device 106. For example, the targeting system can be a program and/or computer implemented process stored in processor readable memory accessible by a processor affiliated with data warehouse and analyzer 104 and/or user device 106.

By way of example, utilizing information stored in processor readable memory accessed by a processor affiliated with data warehouse and analyzer 104, the targeting system can utilize a value generated from an exception process plotted along with historical and/or hierarchical exception information to, for example, generate multiple and/or different statistical populations in which points can be associated based off of a factoring algorithm that can take into account how many deviations the value may be from normal and/or correlated with various key performance indicators to produce a composite risk score. This targeting system can be capable of comparing, using processors, different types of data, stored in processor readable memory, by creating a common definable unit of measurement that data types can be converted to. This can be done so that comparisons can be completed using the same unit of measurement, for example, increasing the accuracy of the comparison.

In exemplary embodiments, at step 204, after identifying a notification, the user can be contacted, via a communication portal affiliated with user device 106, and, at step 206, a notification can be created, using a processor accessing information stored in processor readable memory affiliated with data warehouse and analyzer 104, and/or communicated, via a communication portal affiliated with data warehouse and analyzer 104 to a communication portal affiliated with user device 106, using the defined delivery method for that user. The notification can be communicated, via a communication portal, to the user where the user can receive the notification, via the communication portal, based on the defined delivery method for that user, at step 208. The user can then be able to view, on a graphical user interface, the notification, stored in processor readable memory accessible by a processor affiliated with user device 106, at step 210.

In exemplary embodiments, with respect to step 206, the system and methods can allow for delivery methods to be defined, for example, by the user by any format and/or delivery type, such as, but not limited to, email, SMS, MMS, mobile message to mobile device, and callback number, to name a few.

In exemplary embodiments, at step 212, the user can be able to use a link (e.g., hyperlink, a reference to data that the reader can directly follow, a reference to data that can be followed automatically, etc.) to contact data warehouse and analyzer 104 to view the notification. After contact, the data warehouse and analyzer 104 can start to retrieve, using a processor, the notification data, stored in processor readable memory, for the user, at step 214, and log the user activity, in processor readable memory, at step 215. When the data has been retrieved and formatted, using the processor, the user can be presented the data, on the graphical user interface affiliated with user device 106, in a compatible format for the delivery, via a communications portal, method selected, at step 216. At step 218, the user can have options for interaction such as, but not limited to, do nothing, interact with the data being presented, and/or modify the date being presented, to name a few. The users activities, at step 216, can be logged, in processor readable memory affiliated with data warehouse and analyzer 104 and/or user device 106, at step 215. Based off the logged activities a monitoring component, at step 217, can process, using processors affiliated with data warehouse and analyzer 104 and/or user device 106, various notification, stored in processor readable memory, for reporting, via a communications portal and/or on a graphical user interface, of successful processing of activity, escalation for inactivity, and/or can be used for other various monitoring activities.

It will be understood that any of the steps described can be rearranged, separated, and/or combined without deviated from the scope of the disclosure. For ease, steps are, at times, presented sequentially. This is merely for ease and is in no way meant to be a limitation.

Further, it will be understood that any of the elements and/or exemplary embodiments of the disclosure described can be rearranged, separated, and/or combined without deviated from the scope of the disclosure. For ease, various elements are described, at times, separately. This is merely for ease and is in no way meant to be a limitation.

While the various steps, elements, and/or exemplary embodiments of the disclosure have been outlined above, it is evident that many alternatives, modifications and variations will be apparent to those skilled in the art. The various steps, elements, and/or exemplary embodiments of the disclosure, as set forth above, are intended to be illustrative, not limiting. Various changes may be made without departing from the spirit and scope of the disclosure. Accordingly, the spirit and scope of the present disclosure is to be construed broadly and limited only by the appended claims and not by the foregoing specification.

What is claimed is:

1. A method comprising the steps of:
identifying, using one or more processors, business data associated with problems within a business environment;
generating, using one or more processors, one or more notifications related to the identified business data;
sending, using one or more processors, the one or more notifications to a computer system associated with a user;
monitoring, using one or more processors, the user's interaction with the business data; and
reporting, using one or more processors, the monitored interaction with the business data.

2. The method of claim 1, wherein the step of identifying comprises exception processing.

3. The method of claim 1, wherein the step of sending comprises sending the one or more notifications in a format selected from a group consisting of: e-mail, SMS, MMS, mobile message, and callback number.

4. The method of claim 1, wherein the step of monitoring comprises logging the user's interaction with the business data.
